(19) United States
(12) Patent Application Publication
(10) Pub. No.: US 2011/0071851 A1
(43) Pub. Date: Mar. 24, 2011

(54) Method, Apparatus And Computer Program Product For Facilitating Patient Progression Toward Discharge

(75) Inventors: John Alden, Carmel Valley, CA (US); Mike Myers, Louisville, CO (US); Rick Spates, Canton, GA (US); Keith Willard, St. Paul, MN (US)

(73) Assignee: McKesson Financial Holdings Limited, Hamilton (BM)

(21) Appl. No.: 12/566,149

(22) Filed: Sep. 24, 2009

(51) Int. Cl. G06Q 50/00; G06Q 10/00; G06N 5/02

(52) U.S. Cl. 705/3; 706/47

(57) ABSTRACT

A method, apparatus and computer program product are provided for facilitating patient progression toward discharge. Once a plurality of progression steps to be completed prior to discharge of a patient have been identified, the plurality of progression steps are displayed along with an indication of a status of a respective progression step that indicates whether the respective progression step has been satisfied or remains unsatisfied. The selection of a progression step is then received and, in response, information regarding the selected progression step is displayed. Input data regarding at least one progression step may also be received such that the indication of the status of the at least one progression step may be correspondingly updated. Further, an updated discharge date may be determined based upon the plurality of progression steps and the respective status of the plurality of progression steps as updated based upon the input data.

### TECHNOLOGICAL FIELD

Embodiments of the present invention relate generally to care progression and, more generally, to facilitating patient progression toward discharge in an orderly and efficient manner.

### BACKGROUND OF THE INVENTION

Once admitted to a hospital or other healthcare facility, a team of doctors, nurses and other healthcare professionals work with the patient in accordance with the healthcare plan developed for the patient. The healthcare plan is generally intended to address the patient-specific health issues, such as by taking steps to improve the patient's health or to facilitate the patient's recovery. In many instances, one milestone of a healthcare plan is the discharge of the patient from the healthcare facility. Since the healthcare costs are commonly greater while a patient is admitted to a healthcare facility, the advancement of a patient to discharge in an efficient manner assists in the overall reduction in the healthcare costs. Thus, healthcare plans for a patient admitted to a healthcare facility may both seek to facilitate the recovery or improved health of the patient and to do so in a manner that efficiently moves the patient towards discharge.

Most healthcare plans for a patient admitted to a healthcare facility include a number of individual steps. For example, the healthcare plan may include monitoring the temperature of a patient with an elevated temperature evidencing, for example, a possible infection, working with the patient to become more ambulatory and monitoring the solid and liquid intake by the patient. Because of the numerous individual steps that are combined to form a healthcare plan, it may be difficult to appreciate the manner in which the patient's response or outcome to any individual step will affect the overall healthcare plan and, in particular, will impact the anticipated discharge date of the patient. For example, the unanticipated or undesired response to some of the steps of a healthcare plan may be relatively quickly remedied such that there is little or no effect upon the anticipated discharge date of the patient, while the unanticipated or undesired outcomes to other steps of the healthcare plan may have a meaningful impact upon the anticipated discharge date, such as by delaying the anticipated discharge date of the patient. However, because of the complexity of some healthcare plans and the number of healthcare professionals responsible for implementing the healthcare plan for a patient, it may prove challenging to correlate the outcomes or patient responses to the individual steps of a healthcare plan with any effect upon the anticipated discharge date.

In many instances, a patient who has been admitted to a hospital or other healthcare facility may be treated by a number of different healthcare professionals, including various doctors, nurses, physical therapists and the like. Each healthcare professional may desire relatively quick access to a certain subset of information regarding the patient, but may be much less interested with other information regarding the patient. Due to the oftentimes voluminous amounts of information regarding a patient who has been admitted to a healthcare facility, it may prove challenging or at least time-consuming for a healthcare professional to sift through the information regarding the patient in order to identify the particular subset of the information that is most relevant to the respective healthcare professional. Moreover, the voluminous information regarding a patient who has been admitted to a healthcare facility may also make it challenging for the various healthcare professionals to all remain aware of the general condition of the patient and the overall healthcare plan for the patient, including the anticipated discharge date from the healthcare facility. Instead, the voluminous information regarding the patient may cause a healthcare professional to identify and focus upon that subset of information that is most relevant to them to the exclusion of other, more general information that outlines the healthcare plan for the patient and that may otherwise be beneficial for each of the members of the healthcare team.

As such, it would be desirable to provide improved techniques for documenting the healthcare plan for a patient that permits changes in the anticipated discharge date of the patient that are occasioned by the unanticipated or undesired response of the patient to some of the steps in the healthcare plan to be readily identified. Moreover, it would be desirable to provide improved techniques for both facilitating access of a healthcare professional to the information regarding the patient that is of the most relevance to a respective healthcare professional, while still permitting each of the healthcare professionals to maintain a common understanding of the status of the patient and the overall healthcare plan for the patient.

### BRIEF SUMMARY OF THE INVENTION

Embodiments of the present invention therefore maintain and update a care progression plan of a patient in order to correspondingly update the patient's anticipated discharge date such that changes in the anticipated discharge date of the patient that are occasioned by the unanticipated or undesired response of the patient to some of the steps in the healthcare plan may be readily identified. Moreover, embodiments of the present invention both facilitate access of a healthcare professional to the information regarding the patient that is of the most relevance to a respective healthcare professional, while still permitting each of the healthcare professionals to maintain a common understanding of the status of the patient and the overall healthcare plan for the patient.

According to one embodiment of the present invention, a method for facilitating patient progression toward discharge is provided. The method identifies a plurality of progression steps to be completed prior to discharge of a patient and for which all prerequisites for execution have been met. In regards to identifying the plurality of progression steps, the method also identifies a critical path of progression steps that are to be satisfied to discharge the patient by a discharge order. The method displays the plurality of progression steps and an indication of a status of a respective progression step that indicates whether the respective progression step remains unsatisfied. The method also receives a selection of a progression step and displays information regarding the selected progression step. The method also receives input data regarding at least one progression step and updates the indication of the status of the at least one progression step based upon whether the at least one progression step has now been satisfied or remains unsatisfied. Further, the method determines, such as via a processor, an updated discharge date based upon the plurality of progression steps and the respective status of the plurality of progression steps as updated based upon the input data. In determining the updated discharge date, the method reprojects the critical path based upon the plurality of progression steps and the respective status of the progression steps as updated based on the input data. By appropriately updating the discharge date, the method of one embodiment to the present invention permits a healthcare professional or other user to more clearly understand the effect that the satisfaction of or, in contrast, the failure to satisfy, a progression step has upon the discharge date.

In one embodiment, at least one progression step has associated criteria that must be met in order to be satisfied. In this embodiment, the method may also determine if the criteria associated with the at least one progression step have been met. Additionally, the method of this embodiment may display an indication of the status of the at least one progression step by indicating whether the criteria have been met, are incomplete, or have not been met.

The method of embodiments of the present invention may also receive various types of input. For example, the method of one embodiment may receive an input that requests preparation of a report relating to at least one progression step. In response, the method may automatically prepare the report at least partially based upon the input data. In another embodiment, the method may receive an input requesting preparation of an order with the method of this embodiment also automatically preparing the order in response to the input. In yet another embodiment, the method may receive an input requesting an update of a chart with the method of this embodiment then automatically updating the chart at least partially based upon the input data.

The method of various embodiments may also display a variety of information. In this regard, the method of one embodiment may identify the medical treatment to be performed in association with a respective progression step in conjunction with its display of the plurality of progression steps. In another embodiment, the display of the plurality of progression steps may be differently ordered depending upon the type of user.

The method of one embodiment displays information regarding a selected progression step by displaying a flow diagram of a multi-step medical treatment to be performed in association with the selected progression step and providing an indication of the status of the multi-step medical treatment. In this regard, the indication of the status of the multi-step medical treatment may include separate indications for at least one step of the multi-step medical treatment that has been both initiated and completed and at least one other step of the multi-step medical treatment that has been initiated, but not yet completed.

In one embodiment, the method transforms the input data in accordance with an associated clinical concept to a structured clinical fact. The method of this embodiment may also apply one or more rules associated with the clinical concept to the structured clinical fact and generate additional data as a result of applying one or more rules. For example, the application of one or more rules may include the application of at least one trending rule to the structured clinical fact. Similarly, the generation of additional data may include the generation of data reflective of application of at least a trending rule to the structured clinical fact.

In addition to the method, an apparatus and a computer program product are also provided according to embodiments of the present invention. In this regard, the apparatus includes a processor configured to perform the foregoing functions including, for example, the identification of a plurality of progression steps to be completed prior to discharge, the provision of a display of the plurality of progression steps and an indication of the status of a respective progression step, the reception of a selection of a progression step and the provision of a display of information regarding the selected progression step, the reception of input data regarding at least one progression step and the updating of the indication of the status of the at least one progression step and the determination of an updated discharge date. In another embodiment, the computer program product includes at least one computer-readable storage medium having computer-readable program instructions stored therein. The computer-readable program instructions include program instructions for performing the various embodiments of the method including a program instruction configured to identify a plurality of progression steps to be completed prior to discharge, a program instruction configured to provide for a display of the plurality of progression steps and an indication of the status of a respective progression step, a program instruction configured to receive a selection of a progression step and to provide for a display of information regarding the selected progression step, a program instruction configured to receive input data regarding at least one progression step and to update the indication of the status of the at least one progression step and a program instruction configured to determine an updated discharge date.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a system for facilitating patient progression toward discharge in accordance with one embodiment to the present invention;

FIG. 2 is a schematic representation of the transformation of patient data to a structural clinical fact as provided by a fact repository in accordance with one embodiment of the present invention;

FIG. 3 is a schematic representation of the rationalization of structured clinical facts by the application of a rule as provided by a fact repository in accordance with one embodiment of the present invention;

FIG. 4 is a schematic representation of the trending of structured clinical facts as provided by a fact repository in accordance with one embodiment of the present invention;

FIG. 5 is a block diagram of an apparatus for facilitating patient progression toward discharge in accordance with one embodiment to the present invention;

FIG. 6 is a graphical display presented in accordance with embodiments of the present invention that depicts a care progression plan including a plurality of progression steps ordered based upon the status of each progression step;

FIG. 7 is a graphical display of the type depicted in FIG. 6 in which the uppermost progression step has been selected, and additional information regarding the selected progression step, including a medical treatment to be performed in association with the respective progression step, is provided in accordance with embodiments to the present invention;

FIG. 8 is a graphical display of a chart for a respective patient that may be automatically generated in accordance with embodiments of the present invention;

FIG. 9 is a graphical display of a report relating to at least one progression step that may be automatically generated in accordance with embodiments of the present invention;

FIG. 10 is a graphical display of an order that may be automatically prepared in accordance with embodiments to the present invention;

FIG. 11 is a graphical display of a plurality of patient progression steps that have been reordered based upon the preferences of a different user in accordance with embodiments of the present invention;

FIG. 12 is a graphical display of a plurality of progression steps in which the patient is closer to discharge and the anticipated discharge date has been updated in accordance with embodiments of the present invention;

FIG. 13 is a graphical display of a flow diagram of a multi-step medical treatment to be performed in association with a selected progression step in accordance with embodiments of the present invention;

FIG. 14 is a graphical display of the flow diagram of the multi-step medical treatment depicted in FIG. 13 in which certain steps have been both initiated and completed and other steps have been initiated, but not yet completed in accordance with embodiments of the present invention;

FIG. 15 is a graphical display of the flow chart of the multi-step medical treatment of FIGS. 13 and 14 in which some steps have been both initiated and completed, while other steps (different than the in-process steps of FIG. 14) have been initiated, but not yet completed in accordance with embodiments of the present invention;

FIG. 16 is a graphical display of an updated progression step that provides additional information regarding a step of the multi-step medical treatment including an identification of the next action to be taken in accordance with embodiments of the present invention;

FIG. 17 is a graphical display of the flow diagram of the multi-step medical treatment as depicted in FIGS. 13-15 indicating that the resulting partial thromboplastin time (PTT) score is now within the therapeutic range in accordance with embodiments of the present invention;

FIG. 18 is a graphical display identifying a plurality of patients of a respective healthcare professional as well as a summary indication of the discharge status, alert status, lab result status and transcription status associated with each respective patient in accordance with embodiments of the present invention; and

FIG. 19 is a flow diagram illustrating operations performed in accordance with embodiments of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

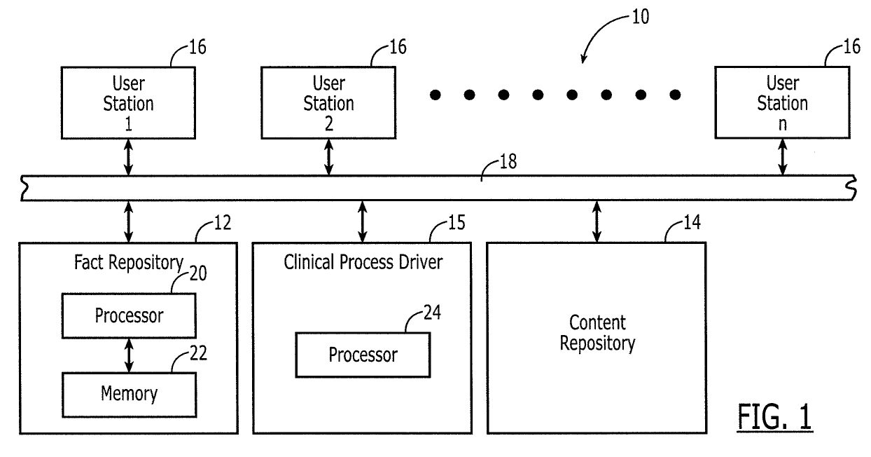

Referring now to FIG. 1, a system 10 in accordance with one embodiment to the present invention is depicted. As described below, the system facilitates the collection, analysis, dissemination and storage of data regarding a plurality of patients and, in one embodiment, facilitates a patient's care progression toward discharge from a healthcare facility. The system of FIG. 1 may be deployed in various manners. For example, the system may be deployed in a single unit or multiple units of a healthcare facility. Alternatively, the system of FIG. 1 may be deployed throughout a healthcare facility and/or distributed across multiple healthcare facilities.

Regardless of its deployment, the system 10 of FIG. 1 may include a fact repository 12, a content repository 14, a clinical process driver 15 and one or more user stations 16 disposed in communication with a bus 18, such as an enterprise service bus. The fact repository may be embodied by a computing device, such as a personal computer, a server or the like. Regardless of its particular implementation, the fact repository generally includes one or more processors 20 and one or more memory devices 22, such as random access memory, in communication with the processor(s). As such, subsequent reference to the performance of various functions by the fact repository may, in one embodiment, entail the performance of those functions by the processor of the fact repository. The processor of the fact repository may be configured to receive data regarding one or more patients. The data may be provided in various manners and, in one embodiment, is provided via the bus from, for example, one or more core clinical systems, such as the Horizon Expert Documentation™, Horizon Expert Orders™ and/or Horizon AdmnRx™ systems. In one example, however, a healthcare professional, such as a physician or a nurse, may collect new or updated data regarding a patient and may provide the data to the system via a user station. Upon receipt of the patient data, the fact repository may process the data and, in some instances, may distribute and/or store a representation of the data.

In one embodiment, the fact repository 12 may enhance the patient data through associations with clinical concepts to form structured data. As a result of the associations with clinical concepts, the fact repository, such as its processor 20, may process the patient data in various manners, such as by transforming the patient data to a standard representation. In this regard, the patient data that is received by the fact repository may be provided in a variety of formats, may not be strongly typed and/or may not have a clear meaning outside of the application in which the patient data originated, such that the transformation to a standard representation facilitates subsequent processing of the patient data. As such, the fact repository may be configured to transform the patient data by extracting the patient data, such as in real time, from various data sources, translating the patient data to strongly typed kinds of data with appropriately strongly typed result values, e.g., numbers, Boolean, strings, etc., and storing the transformed data such as by mapping the data to an ontologically typed longitudinal data store. For example, in instances in which the data represents the patient's temperature, the fact repository may be configured to transform the temperature from a simple string representation, such as 101.9 F, to a strongly-typed internal, floating-point representation of the value. Through associations with clinical terms and rules related to the clinical terms, the fact repository may also determine one or more attributes associated with the transformed value. For example, the fact repository may, in the foregoing example, compare the transformed temperature value to a normal range of temperature values and determine if the patient's temperature is high, normal or low. These attributes may then be stored along with or otherwise in association with the patient data.

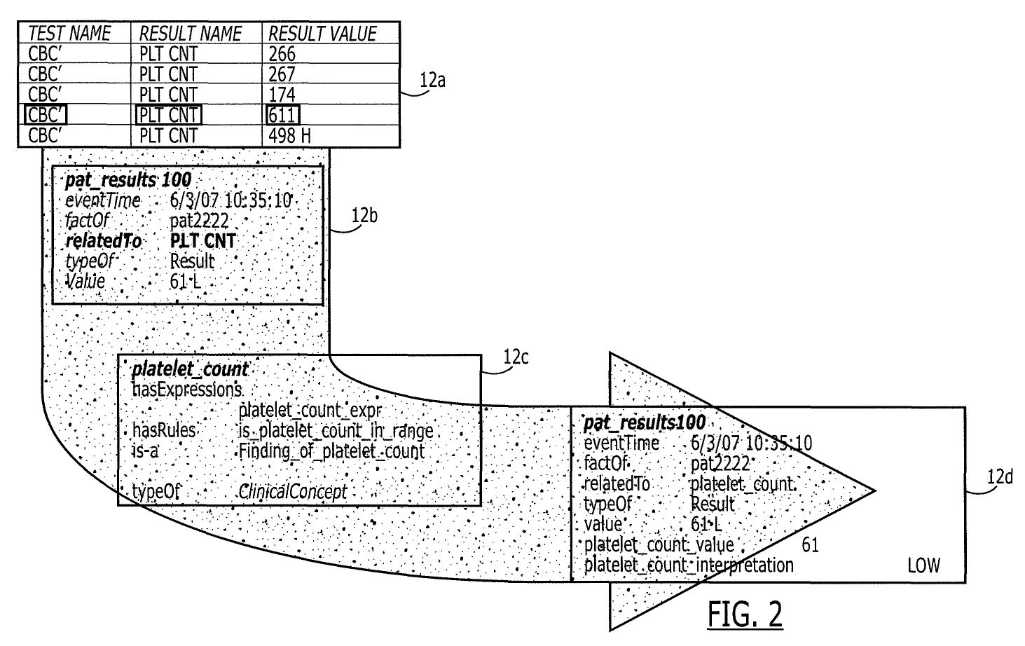

By way of example, FIG. 2 provides a graphical representation of a transformation provided by the fact repository 12. In this regard, the fact repository may store patient test results, such as platelet counts, such as depicted in the table 12a that includes the test name, result name and result value. The patient test results 12b may include a variety of information including the time of the test, the identity of the patient, e.g., pat2222, an indication of the fact to which the test relates, e.g., platelet count (PLT CNT), the type of test, e.g., a result, and the value. Based upon a clinical concept 12c associated with the patient test result, the fact repository may transform the test results to more structured clinical facts 12d. In this regard, clinical concept defines a platelet count value, e.g., 61, and a platelet count interpretation, e.g., low. By representing the platelet count value in a more standard representation, the fact repository permits the platelet count value to be more subjected to rules processing.

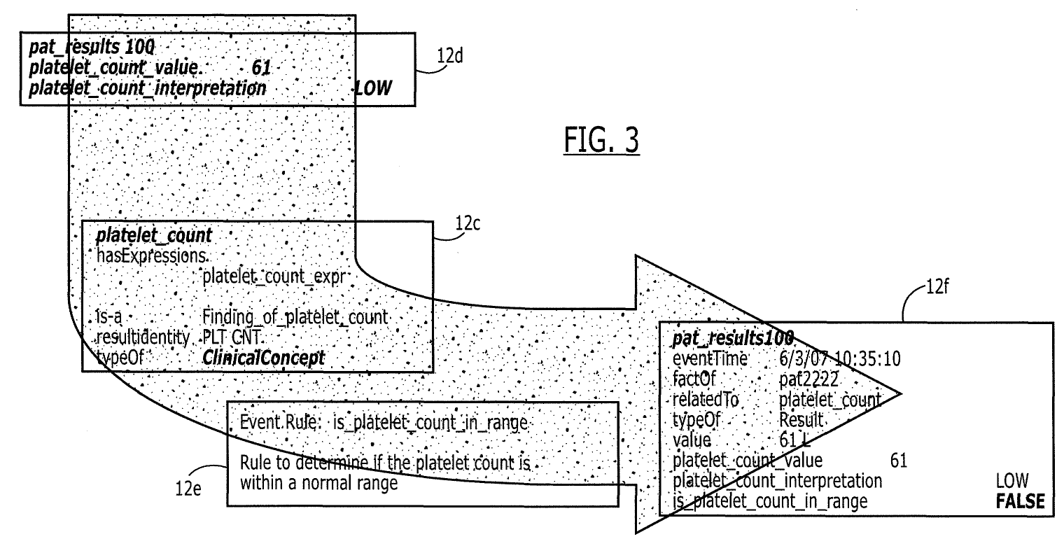

The fact repository 12, such as the processor 20 of the fact repository, may then process the structured data in accordance with rules associated with clinical concepts in order to further characterize and specify the nature of the patient data. As shown in FIG. 3, for example, the fact repository may rationalize the structured clinical facts, e.g., platelet count value and platelet count interpretation, in accordance with an event rule 12e defined by the associated clinical concept 12c. As a result, the patient data may be further characterized with the result of the application of the rule creating additional patient data. In the example of FIG. 3, the application of the rule determines if the platelet count is within a predefined normal range with the resulting additional patient data representing the answer, e.g., True or False, as represented by box 12f. Accordingly, the fact repository may transform patient data, such as to a structured, strongly-typed form, and may then rationalized based on attributes, such as normal, abnormal, outside normal range, within normal range or other applicable attributes.

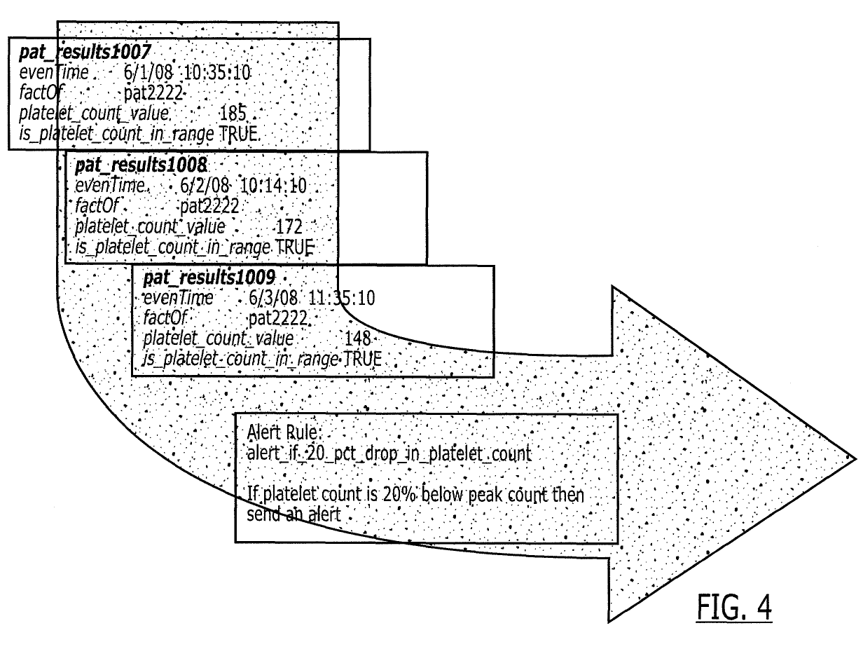

The fact repository 12 may also be configured to determine trends with respect to the patient data. The definition of a trend may be dependent upon the type of patient data. For example, with respect to body temperature, three consecutive body temperature recordings above the normal range within the preceding 12 hours may define a trend that creates an additional clinical fact that may be stored in addition to the underlying patient data. As shown in FIG. 4, the fact repository of one embodiment may be configured to identify a trend from among a series of platelet count values. In this example, the fact repository may be configured to identify a trend and, in one embodiment, trigger an alert to be provided in instances in which the platelet drops at least 20% below a peak count value. As shown in FIG. 4, the trend may be defined by a rule, such as provided by a clinical concept, and may be based upon the rationalized clinical facts. As noted above, the result trend that is identified by the fact repository may create an additional clinical fact.

As shown in FIG. 1, the fact repository 12 may include a memory device 22 associated with the processor 20 for storing the patient data, attributes related to the patient data and clinical facts that are created by analysis of the patient data. While the patient data may be stored within the memory device of the fact repository while and at least shortly after the patient data is processed by the processor of the fact repository, the system 10 of FIG. 1 may also include a content repository 14 configured to provide longer term storage of the patient data, the attributes and related clinical facts. The content repository may be embodied in various manners including a server or one or more memory devices, such as random access memory.

As described below, the clinical process driver 15 may be embodied by a computing device, such as a personal computer, a server or the like and, in any event, generally includes a processor 24 and, in some embodiments, a memory device for ordering and, in some instances, reordering the progression steps of the healthcare plans for each of a plurality of patients in accordance with the protocols defined for each of the patients. The processor 24 may be embodied in a number of different ways. For example, the processor may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor may be configured to execute instructions stored in a memory device or otherwise accessible to the processor. As such, whether configured by hardware or software methods, or by a combination thereof, the processor may represent an entity (e.g., physically embodied in circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor 24, which may in some cases otherwise be a general purpose processing element or other functionally configurable circuitry if not for the specific configuration provided by the instructions, to perform the algorithms and/or operations described herein.

In accordance with one embodiment of the present invention, one or more user stations 16 may be in communication with the fact repository 12 and the clinical process driver 15 via the bus 18. As illustrated in FIG. 1, the system 10 may include a plurality of user stations 16 utilized by a plurality of users designated 1, 2 . . . n. In some instances, a user station is co-located with the patient, such as in or proximate to the patient's room, while in other embodiments a user station is located remotely from the patient, such as in the office or home of the healthcare professional in order to permit the healthcare professional to review the status of the patient from the remote location.

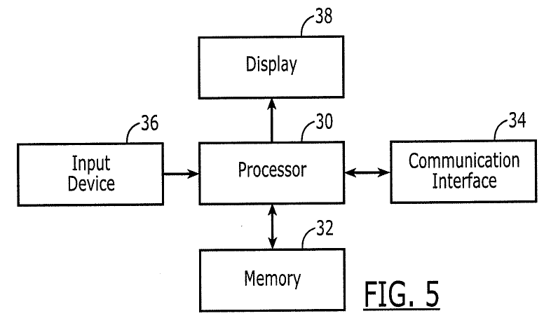

Regardless of their location, the user stations 16 are utilized by various users, such as various healthcare professionals, in order to access the system 10. As noted above, a user station may be comprised of a computing device and the computing device, in turn, may be configured in various manners with one embodiment depicted in FIG. 5. As shown in the illustrated embodiment, the user station may include or otherwise be in communication with a processor 30, a memory device 32, a communication interface 34, an input device 36 and a display 38. In one embodiment, the user station is distributed with the processor located remote from the display and the input device, but in communication therewith via the bus 18. For example, a single processor (or a single group of processors) may support a plurality of user stations in a client server architecture with the processor functioning as the server and a plurality of workstations (each including the input device and the display of a respective user station) functioning as the clients.

Returning to the embodiment depicted in FIG. 5, the memory device 32 may include, for example, volatile and/or non-volatile memory. The memory device may be configured to store information, data, applications, instructions or the like for enabling the apparatus to carry out various functions in accordance with exemplary embodiments of the present invention. For example, the memory device could be configured to buffer input data for processing by the processor 30. Additionally or alternatively, the memory device could be configured to store instructions for execution by the processor. As yet another alternative, the memory device may be one of a plurality of databases that store information and/or media content.

The processor 30 may be embodied in a number of different ways. For example, the processor may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor may be configured to execute instructions stored in the memory device 32 or otherwise accessible to the processor. As such, whether configured by hardware or software methods, or by a combination thereof, the processor may represent an entity (e.g., physically embodied in circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor 30, which may in some cases otherwise be a general purpose processing element or other functionally configurable circuitry if not for the specific configuration provided by the instructions, to perform the algorithms and/or operations described herein. However, in some cases, the processor may be a processor of a specific device (e.g., a mobile terminal or server) adapted for employing embodiments of the present invention by further configuration of the processor by instructions for performing the algorithms and/or operations described herein.

Meanwhile, the communication interface 34 may be any means such as a device or circuitry embodied in either hardware, software, or a combination of hardware and software that is configured to receive and/or transmit data from/to the bus 18. For example, the communication interface may include a communication modem and/or other hardware/software for supporting communication via cable, digital subscriber line (DSL), universal serial bus (USB), Ethernet or other mechanisms.

The display 38 is in communication with the processor 30, which drives the display to present a graphical interface. Similarly, the input device 36 is in communication with the processor to receive an indication of a user input. As such, the input device may include, for example, a keyboard, a mouse, a joystick or other input mechanism.

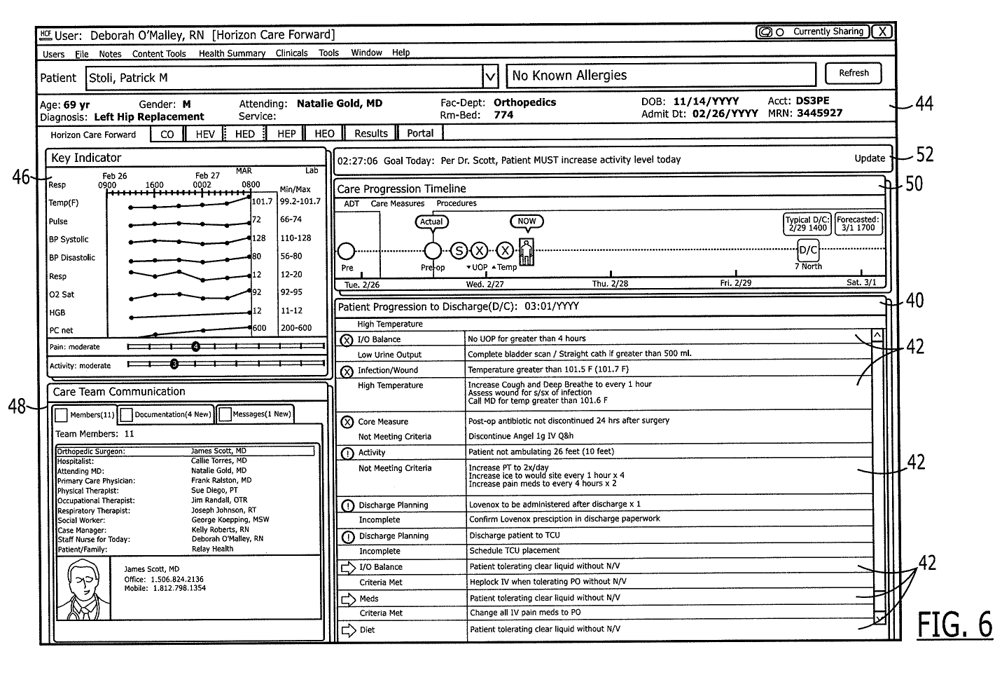

The clinical process driver 15, such as the processor 24, is configured to provide a user station 16 with the care progression plan 40 of a patient including the plurality of progression steps 42 to be completed prior to discharge of the patient. In this regard, the user station may request that the clinical process driver provide the case progression plan of a particular patient and may thereafter display the care progression plan, e.g., the processor 30 may direct the display 38 to present a graphical interface including the care progression plan. Accordingly, subsequent reference to a graphical interface, such as in conjunction with FIGS. 6, 7, 11 and 12, refers to graphical interfaces that are generated by the processor of a user station and presented via the associated display.

Regarding the provision of the progression steps of a healthcare plan by the clinical process driver 15, a user station 16 may subscribe to events from the clinical process driver in order to receive instructions regarding the next progression steps to be executed. The clinical process driver, in turn, may subscribe to the fact repository 12 in order to receive certain types of patient data regarding particular patients. As used hereinafter, patient data may refer to any one or more of the patient data, the attributes related to patient data and the clinical facts derived from patient data. The fact repository may store or otherwise have access to information defining the patient data and may then distribute the patient data to the clinical process driver in accordance with the respective subscription. In addition to simply distributing the patient data, the fact repository may be configured to identify predefined alert conditions, such as in response to the patient data exceeding or falling below a predefined threshold or a clinical fact of a predefined type being generated based upon the patient data. In this embodiment, the clinical process driver may also subscribe to be notified of alerts, or at least certain types of alerts. Accordingly, the fact repository may be configured to notify the clinical process driver that has subscribed to be notified of a particular type of alert in instances in which the alert has been identified.

The clinical process driver 15 may combine the patient data and, in some instances, structured clinical facts and/or alerts received from the fact repository 12 with a patient's healthcare plan as defined by the respective protocol to determine the next progression steps and the healthcare professional responsible for the performance of each progression step. Once a user station 16 is actively connected to the bus 18, such as by being logged in via a procedure that identifies the healthcare professional utilizing the user station and the patient of interest, the clinical process driver may send the user station a list of the progression steps that are awaiting execution for the respective patient in order to permit the healthcare professional to act on those assigned to him/her. The user station may also subscribe to the fact repository to obtain other patient information that is relevant to the care of the patient and, as such, may be displayed.

The care progression plan as provided by the clinical process driver 15 is generally based upon a protocol that has been designed by the healthcare professional(s) responsible for the care of the patient. The healthcare plan may range from a relatively simple plan involving only a few progression steps to a plan potentially involving hundreds of progression steps that are to be performed by one or more healthcare providers. In at least some instances, the sequence in which the progression steps are performed is of importance and may, indeed, be critical. For example, a diagnostic test may need to be performed prior to the administration of a medication since the administration of the medication prior to the diagnostic test could, for example, invalidate the test results. The clinical process driver of one embodiment is configured to determine the proper sequencing of the plurality of progression steps and to ensure that the healthcare plan represented by the plurality of progression steps provided to the user station 16 is provided in the proper sequence. In this regard, the clinical process driver may determine the proper sequence based upon a number of predefined rules that govern the relative order of various types of progression steps. Although the sequence of some progressions steps within a protocol may be of importance in some instances, a protocol may include many different logical paths that may be processed in parallel. For example, further progression along one path may be stalled awaiting the arrival of a particular piece of data, while other paths can be advanced because progression along the other paths is not dependent upon the same piece of data. In order to respond quickly to the receipt of the piece of data, the processor may determine in advance the response, e.g., the next steps, for one or more potential values of the data, including the worst case response. As such, upon receipt of the data, the processor can respond quickly and, in some instances, instantaneously. As another example, the progression along several paths may be stalled waiting for receipt of various pieces of data. The processor may therefore determine the next steps, e.g., remediation events in case the data is indicative of an adverse event, for each of the paths in parallel.

In one embodiment, the plurality of paths defined by a protocol each include one or more progression steps for each of a number of different aspects of the patient's care, e.g., different categories of care, different focuses of care, different specialties of care or the like. For example, the healthcare plan may include progression steps relating to nutrition, activity, tests/labs, medications, assessment/treatments, e.g., inputs and outputs or daily weights, therapy and the like. A patient may advance through the progression steps of each different aspect of the patient's care at a different rate. For example, a patent may advance quickly through the progression steps associated with the patient's activity, but may progress much more slowly through the progression steps associated with the patient's nutrition. Thus, a patient's protocol of one embodiment is not a sequential series of steps, but one or more progression steps associated with different aspects of the patient's care with the patient advancing through the progression steps associated with the different aspects in parallel, albeit potentially at different rates.

Within the healthcare plan of a patient, some of the progression steps may be delayed, at least for a limited period of time, without impacting the quality of care or the projected discharge date. However, many healthcare plans include a set of steps that are critical to achieving a timely resolution of the case, such as represented by the discharge of the patient following a successful recovery or the like. The set of steps that are critical to achieving a timely resolution of a case are termed the critical path of progression steps and may vary over time during the treatment depending upon the outcome of the various progression steps and any additional progression steps that must be inserted into the healthcare plan in response to the outcome of prior progression steps. The clinical process driver 15 of one embodiment is configured to identify the set of steps that are critical to the timely resolution of the case, such as by identifying the set of steps from the healthcare plan that must be performed in order to avoid delay of the discharge date, that is, the delay of any of the progression steps in the set of progression steps identified to be critical necessarily would delay the discharge date. The clinical process driver may be configured to repeatedly determine or re-project the set of progression steps that are critical as earlier progression steps are completed and the outcomes thereof and other input are taken into account. In addition to identifying the progression steps that are considered to be critical, the clinical process driver may also identify the healthcare professionals responsible for each of the critical progression steps and, in one embodiment, may also determine the time consequences of delays in completing the various critical progression steps. The clinical process driver generally receives a flow of patient information from the fact repository 12 and repeatedly assesses a patient's progress relative to the healthcare plan as defined by the protocol established for the patient and in accordance with protocols and rules provided by the content repository. Among other things, the clinical process driver may repeatedly update the progression steps of the healthcare plan and may similarly reproject the critical path of progression steps as time elapses and the outcomes of prior progression steps are known and, similarly, the clinical process driver may update the anticipated discharge date based on the progress of the patient to date.

The clinical process driver 15 may also be configured to determine, for each progression step of a healthcare plan, if the progression step has or has not performed in a timely manner. As described below, the clinical process driver can direct a user station 16 to display an indicator in association with the respective progression step that indicates that the performance of a respective progression step is overdue. For example, the clinical process driver may direct the display of a indicator having a green color in instances in which the progression step is not yet overdue, a yellow color in instances in which the progression step will become overdue in the near future or has recently become overdue and a red color in instances in which the progression step has been overdue for some time. Typically, the clinical process driver directs the user station to display the indicator so as to be visible to all healthcare professionals and not just the healthcare professional responsible for the performance of the progression step in question. In instances in which a progression step remains incomplete and overdue for a predetermined period of time or in instances in which the failure to perform the progression step is beginning to adversely impact the discharge data of the patient, a clinical process driver may trigger a predefined intervention, such as by sending an alert notifying the attending physician or the like of the overdue progression step.

The clinical process driver 15 may also be configured to execute certain ones of the progression steps directly so long as the progression steps have been preapproved by clinicians or other healthcare professionals. For example, the clinical process driver may place orders for lab tests, medications, etc. In addition, based upon the information received from the fact repository 12, the clinical process driver may also determine abnormal or adverse patient conditions and initiate predefined actions to resolve these situations including, for example, notification of the appropriate healthcare professional.

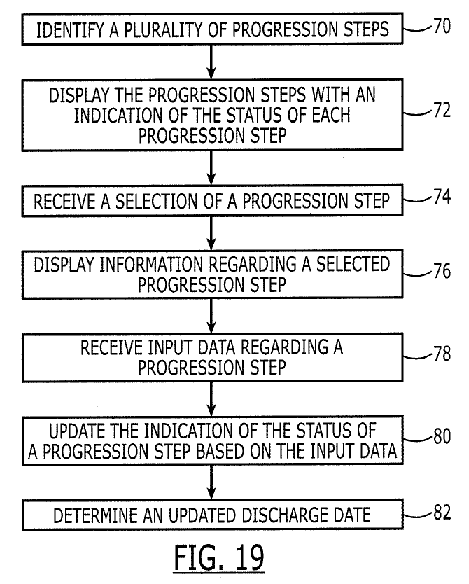

As shown in the graphical interface of FIG. 6, for example, a plurality of progression steps that must be completed prior to discharge may be identified. As depicted in blocks 70 and 72 of FIG. 19, the processor 24 of the clinical process driver 15 may identify the plurality of progression steps and may then provide the progression steps to the user station 16 for display of the progression steps along with an indication of the status of each respective progression step. In this regard, the indication of the status indicates whether the respective progression step has been satisfied, is incomplete or is unsatisfied. By way of example with respect to FIG. 6, the care progression plan that is provided by the processor of the clinical process driver and displayed via the graphical interface includes progression steps relating to the patient's urine output, the patient's temperature, the discontinuation of the post-op antibiotic, the ambulatory movement of the patient, activities associated with discharge planning, the patient's tolerance to clear liquids, and the change in delivery of the patient's pain medications. Each progression step also includes predefined criteria, the satisfaction of which causes the respective progression step to be satisfied. The criteria will vary depending upon the nature of the progression steps and may be, for example, a measurable quantity such as temperature, volume of urine output or distance walked, or may be some activity performed by the patient and/or a healthcare professional, such as a pre-discharge meeting regarding ongoing diet restrictions.

The indication of the status of each progression step may be represented in various manners. In addition, different types of status may be defined depending upon the type of progression step at issue. In the graphical display of the embodiment of FIG. 6, however, three different types of status are represented, namely, a status in which the criteria for the progression step have not been met, a status in which the progression step is incomplete and a status in which the criteria of the progression step have been met even though the progression step has not been completed. The indication of the respective status may be provided by the clinical process driver 15 to the user station 16 as noted above, and may be presented by the user station in various manners, such as by means of a textual note associated with the progression steps.

In addition to the care progression plan 40 including the plurality of patient progression steps 42, the graphical display presented by the processor 30 of a user station 16 may include additional information displayed, for example, in other windows. The type of additional information and its manner of display may be widely varied. In the illustrated embodiment, for example, the graphical display includes a banner 44 providing information regarding the patient including the patient's name, age, sex, the attending physician, the patient's room, date of birth, admission date, account number, medical record number and diagnosis. The graphical display of the illustrated embodiment may also include a window 46 depicting one or more parameters, designated key indicators, that may illustrate the manner in which the various parameters have fluctuated or stayed the same over the course of time. The parameters depicted in window 46 may be provided by the fact repository 12 in one embodiment. While the graphical display of FIG. 6 depicts one set of parameters, the choice of parameters may be varied depending upon, for example, the diagnosis of the patient, the care progression plan and the desires of the healthcare professionals implementing the care progression plan.

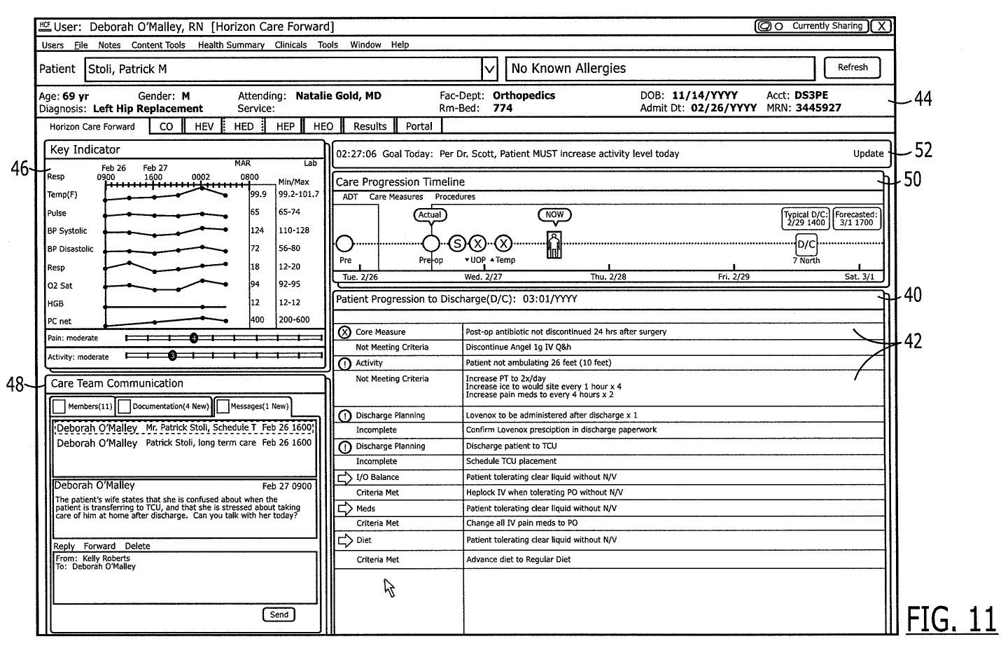

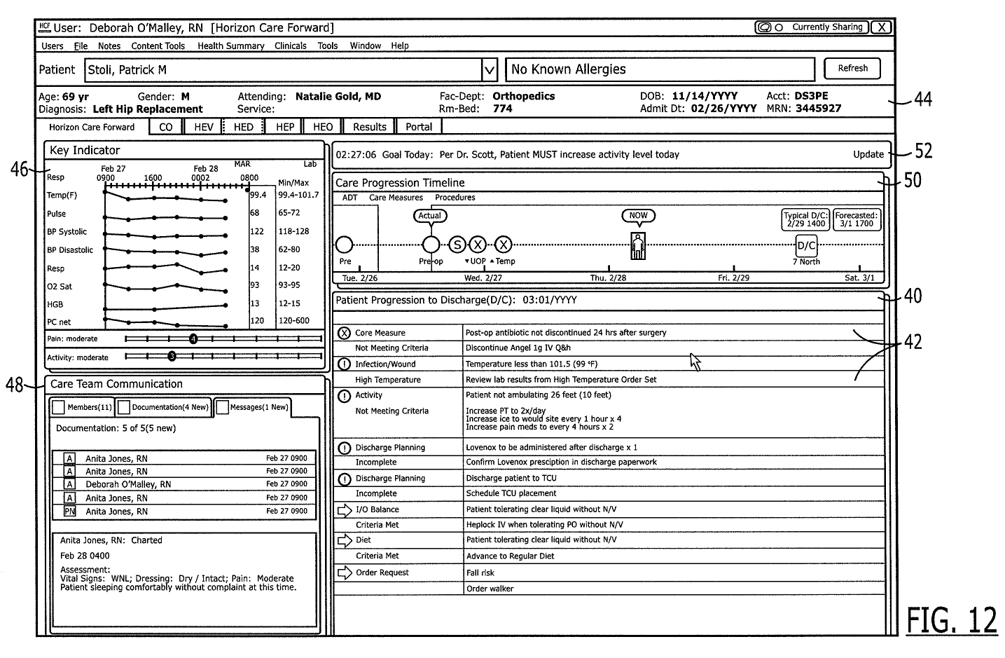

The graphical display presented by the processor 30 may, in the illustrated embodiment, also identify the plurality of healthcare professionals attending to the patient and may provide a window 48 that presents contact information for the various healthcare professionals along with a tool for facilitating communications, such as Instant Messaging or email communications, between one or more of the healthcare professionals (see FIG. 11) and/or a tool for indicating documentation regarding the patient that has been input by one or more of the healthcare professionals (see FIG. 12). The information presented via window 48 may be provided, for example, by the fact repository 12 and/or the clinical process driver 15.

As depicted in FIG. 6, the clinical process driver 15 may provide and the graphical display of the user station 16 may include a care progression timeline 50. As shown, the care progression timeline depicts significant points in time, such as a preadmission visit or screening of the patient (designated “Pre”), the admission of the patient (designated “Pre-op” or “Admit”), the surgery (designated “S”), the current time, and/or a forecast of the discharge date based upon the care progression plan and the current status of the plurality of progression steps 42. As shown in the care progression timeline, the dates and/or times at which the care progression steps were determined to be unsatisfied may also be indicated. In one embodiment, the times at which the progression steps were determined to be unsatisfied may be represented along the timeline by the same icons that are indicative of the status of the unsatisfied progression steps, e.g., a circled X, along with an alpha-numeric indication of each respective progression step. In the illustrated example, the timeline may include an icon indicative of a low urine output (UOP) and an icon indicative of a high temperature (TEMP). In addition to the anticipated or forecasted discharge date, the typical discharge date of a patient having the same diagnosis or undergoing the same procedure may also be represented on the timeline as a point of reference to readily determine if the patient is progressing faster or slower than an average patient having the same diagnosis. As described hereinafter, some of the events represented along the timeline are fixed, such as the time of admission, the time of surgery and the time at which particular progression steps were determined to be unsatisfied. However, other events may change, such as the anticipated or forecasted discharge date may move forward or backward along the timeline depending upon the progression of the patient. Further details regarding a care progression timeline are provided by U.S. patent application Ser. No. 12/365,681, filed Feb. 4, 2009, the contents of which are incorporated herein in their entirety.

Finally, the graphical display of the embodiment of FIG. 6 may include a window 52 that designates one or more goals for the present day, such as to increase in the activity level of the patient. By highlighting one or more goals for the current day, each healthcare professional who is attending the patient can readily determine the goal(s) and can work in concert to support accomplishment of the goal. In one embodiment, the goals are provided to the user station 16 by the clinical process driver 15.

While one example of a graphical display is shown in FIG. 6 and is described above, the graphical display presented by the processor 30 of the user station may be configured in a wide variety of different manners with the graphical display of some embodiments including only the care progression plan 40 including the plurality of progression steps 42, while the graphical displays of other embodiments include one or more additional windows providing other information related to the patient. As such, a healthcare facility and/or a healthcare professional can configure the graphical display to include the types of information, if any, in addition to the care progression plan including the plurality of progression steps that are of interest and are to be displayed.

The care progression plan 40 may be configured such that various types of information are displayed in conjunction with each of the progression steps 42. In the illustrated embodiment, the type of progression step, such as I/O balance, infection/wound, core measure, activity, discharge planning, meds or diet, is displayed along with an indication of the status of the progression step with the indication of the status being provided, as described above, with an alpha-numeric description, such as Not Meeting Criteria, Incomplete or Criteria Met. Additionally, each progression step can provide additional information, such as information relating to the criteria that must be satisfied or failed to satisfy the criteria associated with the respective progression step. In the embodiment of the graphical interface depicted in FIG. 6, the uppermost progression step relating to I/O balance has not been satisfied because of a low urine output which is further defined as being no urine output (UOP) for more than four hours. Similarly, the progression step relating to an infection/wound has not been satisfied as a result of the patient having a high temperature which is further defined as being a temperature greater than 101.5 F. Further, a core measure has not been satisfied since, as further detailed by the example of the care progression plan of FIG. 6, the post-op antibiotic was not discontinued within 24 hours after surgery. The care progression plan can include analogous details in conjunction with those progression steps that are either incomplete or for which the criteria have been met as similarly exemplified by the graphical display of FIG. 6.

Additionally, the care progression plan 40 can identify the next step(s) to be taken in instances in which a progression step has not been satisfied in an effort to subsequently satisfy the progression step. For example, the progression step relating to I/O balance that has not been satisfied because of the low urine output identifies that a complete bladder scan should be conducted with the patient subjected to a straight catheterization if the bladder scan indicates that the patient is retaining more than 500 ml of urine. Similarly, the progression steps that are incomplete may include additional information that identifies the activity that is to be performed in order to complete the respective progression steps. Further, the progression steps that are not yet complete even though the criteria are satisfied include an indication of the activities that were previously conducted in order to meet the criteria.

As noted above, the care progression plan 40 of the embodiment depicted in FIG. 6 provides information regarding each respective progression step and the manner in which the criteria for the progression step either have been met, are incomplete, or have not been met. In addition, the clinical process driver 15 may provide an icon associated with each progression step that is coded, such as by coloring, to indicate the relative severity of the progression step from a timing standpoint. For example, a green arrow may indicate that the progression step may still be performed in a timely manner and is not causing a delay of the discharge date. A circled exclamation point may indicate that the progression step needs to be performed in the near future to avoid delaying the discharge date, while a circled X icon may indicate an overdue progression step that may be delaying the discharge date. As shown in FIG. 6, the progression steps may be ordered based on this relative severity.

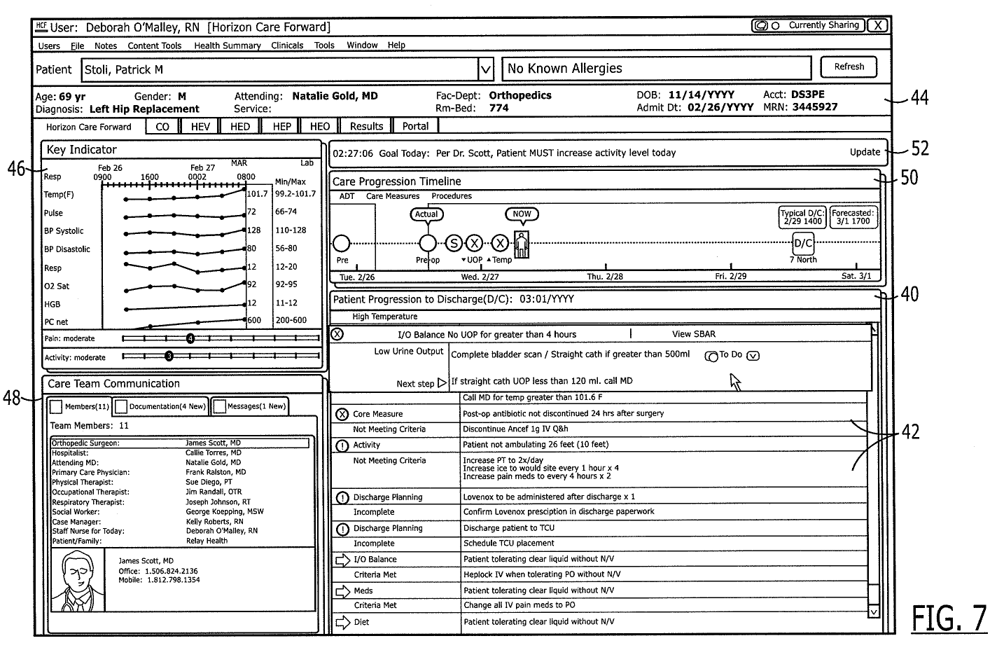

However, the processor 24 of the clinical process driver 15 may provide additional information regarding a progression step upon selection of the respective progression step. See operations 74 and 76 of FIG. 19. In this regard, as shown in the graphical interface of FIG. 7, a user has selected the uppermost progression step relating to I/O balance that remains unsatisfied because of a low urine output. The processor provides additional information via the graphical interface regarding the steps to be taken in an effort to satisfy the progression step, including conditional steps to be taken in the event of certain predefined outcomes, such as a phone call to the attending physician if the straight catheterization of the patient results in a urine output of less than 120 ml. Also, by selecting the rightmost icon, a pull down list with configurable choices may be provided. These choices may vary by the nature of the progression step but a set of representative samples may be:
“Order” means place the Order defined in this progression step
“Chart” means chart the observation defined in this progression step
“Accept” means comply with the instruction being given in this progression step
“Decline” means the clinician does not wish to follow the direction given in the progression step
“Defer” means the clinician wishes to delay execution of the [progression] step
“Delegate” means the clinician wishes to delegate this step to another care giver

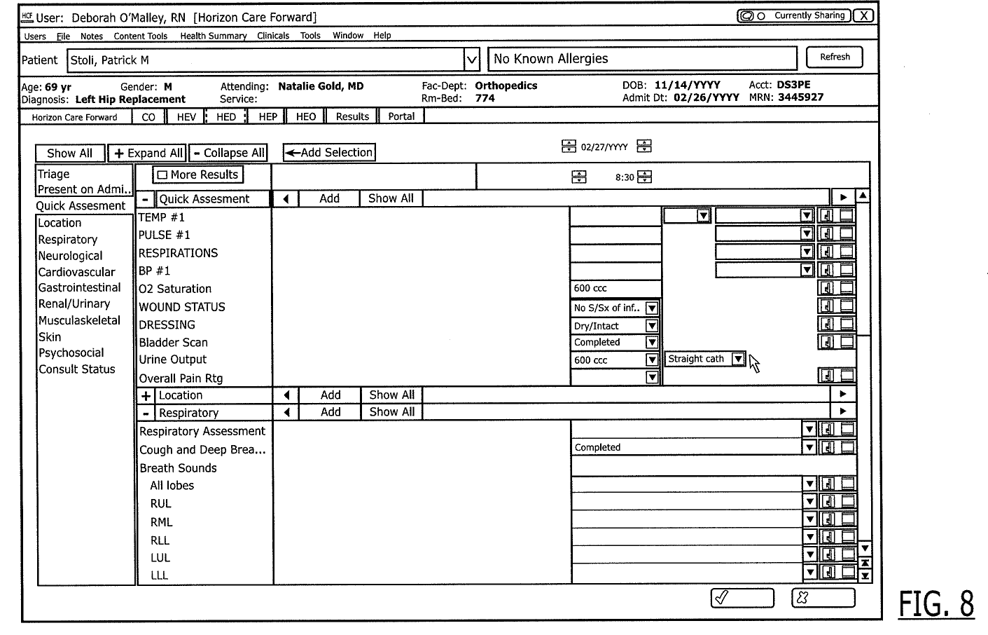

A healthcare professional may therefore interact with the processor (e.g., processor 20, 24 and/or 30) in order to request the display of an electronic chart associated with the patient, such as by making an appropriate selection from the menu or tool bar of the graphical display. In response to the request, the processor is configured to automatically generate a chart for the patient including a plurality of predefined fields populated with the patient data, such as retrieved by the processor from the associated memory device. One example of a chart that is intended to permit a healthcare professional to make a quick assessment of the patient is depicted in FIG. 8. As indicated by the categories in the leftmost column of the graphical display, other more detailed charts, such as the charts relating, in particular, to the respiratory, neurological, cardiovascular, gastrointestinal, renal/urinary, musculoskeletal, skin or psychosocial aspects of the patient may be similarly provided. In addition to providing information to the user, a user may also add information to the chart, such as based upon recent test results, observations or the like, in order to update the chart. In this regard, the user may update the electronic chart by making selections from dropdown menus or by entering input data into various boxes associated with different fields of the chart. In response to the input data provided by a user in the course of updating a chart, the processor may not only update the chart, but may also store the input data in memory.

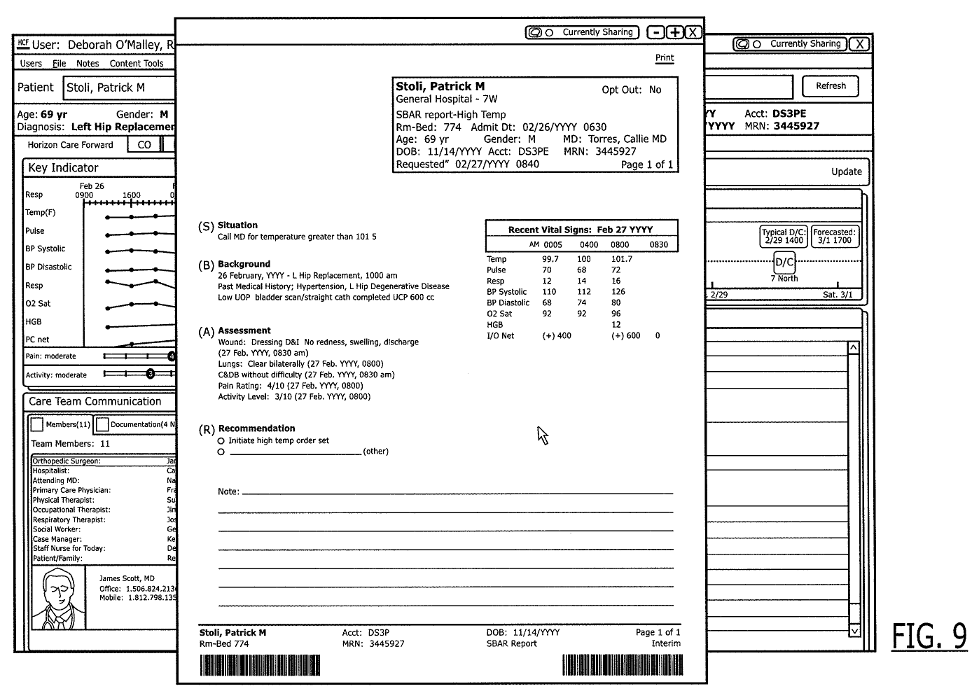

In addition to a chart, the processor (e.g., processor 20, 24 and/or 30) may permit a healthcare professional to prepare a report regarding the patient in an efficient manner. In this regard, the healthcare professional can indicate a desire to prepare a report, such as by making a selection from a dropdown menu or toolbar. The report may relate to a selected one of the patient progression steps and, as such, the processor may automatically generate the report so as to be pre-populated with information relating to the respective progression step. In the report of FIG. 9, the patient progression step relating to a high temperature may be selected. In particular, the patient progression step indicates that a physician is to be contacted if the temperature exceeds 101.5 F. As such, a recent temperature reading of 101.7 F may trigger the processor to generate the report with the “situation” field indicating that a physician was to be called for temperatures greater than 101.5 F. As shown in the example of FIG. 9, the report may also be automatically pre-populated with information regarding the patient and the background of the procedure as well as the patient's most recent vital signs. The healthcare professional can then make an assessment or update a prior assessment. As shown in the example of the report of FIG. 9, the assessments consist of assessments made at two different times and compiled within the report. The healthcare professional can also make a recommendation for further steps to be taken. In this regard, certain types of patient progression steps may have one or more recommendations that are generally made in an effort to satisfy the respective progression step. As such, these typical types of recommendations may be included in the report and available for selection by the healthcare professional. As shown in FIG. 9, the healthcare professional can also enter another recommendation with which the report has not been pre-populated.

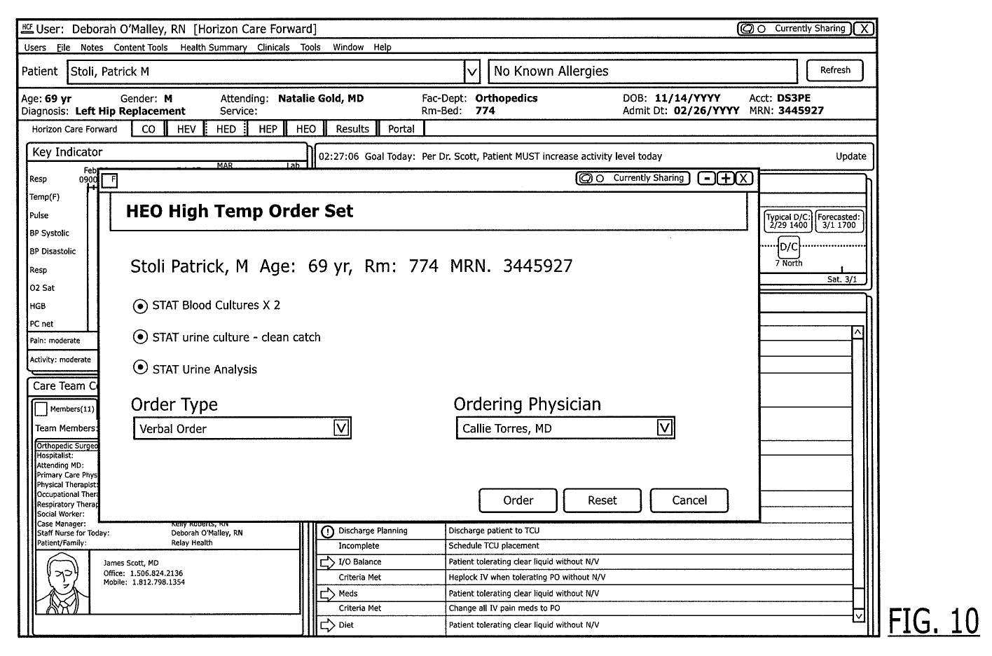

Based upon the recommendation that the healthcare professional selects in the report, the processor (e.g., processor 20, 24 and/or 30) can automatically generate a corresponding order. In this regard, if the healthcare professional selected the recommendation to “initiate high temp order set” from the report of FIG. 9, the high temp order may be automatically generated by the processor as shown, for example, in FIG. 10. In this regard, the high temp order is predefined by the processor to include three distinct activities and to identify the type of the order and the ordering physician, along with basic information regarding the patient. Upon the selection of “order” by the healthcare professional, the high temp order set is entered and the appropriate healthcare professionals, such as the nurses attending the patient, will be notified to perform the various activities that comprise the order. In this regard, the processor may update the care progression plan 40 to identify the additional steps to be taken in conjunction with the respective patient progression step in an effort to satisfy the respective patient progression step.

In addition, the processor of some embodiments may be configured to automatically place an order or to automatically place a pre-order (which is automatically populated by the processor and then reviewed by a healthcare professional prior to execution) in order to advance the patient's care according to the healthcare plan without the physical entry of the order. The processor of this embodiment may be configured to automatically place an order or a pre-order based upon the status of one or more progression steps, such as the completion or satisfaction of one or more progression steps. For example, the patient who may be eligible for an advanced diet based on the patient's tolerance of fluids would conventionally require a unit secretary or nurse to enter the order for a solid diet once it has been noticed that the patient is tolerating fluids. Due to the complexity of healthcare plans, the entry of this order could be easily overlooked or delayed. However, the processor of some embodiments may be configured such that when a predefined fluid intake is documented an order is automatically generated for a solid diet, thus expediting the care of the patient, reducing the workload of the nursing staff and preventing any delays.

The processor 24 of the clinical process driver 15 is configured to update the care progression plan 40 as the patient's care progresses and steps are taken to satisfy each of the patient progression steps 42. See blocks 78 and 80 of FIG. 19. Since a care progression plan 40 may include numerous steps, such as hundreds of steps, steps that have been completed may be removed from the display in some embodiments to avoid information overload.

The care progression plan 40 provided by the processor 24 and presented within the graphical display may be ordered based upon the status of the various progression steps. For example, the progression steps that are overdue may be listed first, followed by the progression steps that are approaching overdue status and the progression steps that are not yet due, as shown in FIG. 6. However, the processor may differently order the progression steps in other embodiments or in other situations. For example, the care progression plan may be accessed by a variety of healthcare professionals, including physicians, nurses, physical therapists and the like. In one embodiment, each user must separately log in and correspondingly provide identifying information to the processor. As such, the processor of one embodiment may order the care progression plan in a different manner depending upon the user and, more particularly, depending upon the job description or role of the user. In this regard, a nurse who is responsible for scheduling and discharge activities may be presented with a graphical display that includes a care progression plan in which the progression steps associated with discharge planning are listed at the top of the care progression plan, as shown in FIG. 11. The processor may order the progression steps in still other manners for display to different types of users or in different situations. For example, a dietitian accessing the care progression plan may be presented with a care progression plan in which the progression steps relating the patient's diet are listed initially or at the top of the care progression plan. As such, this embodiment of the present invention facilitates efficient access of a healthcare professional to the information regarding the patient that is of the most relevance to a respective healthcare professional.

In accordance with embodiments of the present invention, the processor 24 of the clinical process driver 15 may not only update the care progression plan 40 including one or more of the progression steps 42 depending upon the most recent information regarding the status of the patient, but the processor may also repeatedly determine the anticipated or forecasted discharge date of the patient based upon the updated information regarding the patient and the status of each of the progression steps. See block 82 of FIG. 19. In this regard, the examples of the graphical displays that have been described heretofore, such as the graphical displays of FIGS. 6, 7 and 11, have been generated by the processor during the morning of February 27. After taking into account the updated information regarding the patient that is entered throughout the remainder of the day on February 27 and early in the morning of February 28, the processor can update the care progression plan and can correspondingly update the anticipated discharge date for presentation in a graphical display as shown, for example, in FIG. 12. In this regard, the anticipated discharge date has been moved up by about three hours relative to that previously determined by the processor and displayed in the graphical interface of FIG. 1. By updating the anticipated discharge date, a healthcare professional can remain aware of the manner in which the patient's response or outcome to any individual step will affect the overall healthcare plan and, in particular, will impact the anticipated discharge date of the patient, thereby facilitating the treatment of the patient in such a manner as to efficiently work toward the discharge of the patient.

The processor 24 may be configured to determine the anticipated discharge date in accordance with a predefined algorithm. Although the algorithm may be constructed in a number of different manners, the processor of one embodiment begins with an anticipated discharge date that equals the average discharge date for a patient having the same procedure or otherwise suffering from the same condition. Thereafter, the processor updates the anticipated discharge date based upon the satisfaction, or not, of the patient progression steps and the time required to satisfy each progression step. In this regard, at least some of the progression steps may be associated with a time period within which the progression step is satisfied, on average. In instances in which the patient progression steps are satisfied in the time period associated with the respective progression steps, the processor may maintain the anticipated discharge date at the same day and time. However, if one or more of the progression steps are not satisfied within the time period that is associated with the respective progression step, either by satisfying the progression step sooner than anticipated or failing to satisfy the progression step within the time period associated with the progression step, the processor may be configured to accordingly adjust the anticipated discharge date. In this regard, the processor may be configured to alter the anticipated discharge date by predefined amounts depending upon the manner in which a respective progression step is unsatisfied. For example, the failure to satisfy a progression step relating to an infection/wound as a result of a high temperature may cause the processor to delay the anticipated discharge date by a first predetermined period of time, while the failure to satisfy a progression step relating to a core measure in which the patient fails to discontinue an antibiotic within twenty-four hours of surgery may cause the processor to delay the anticipated discharge date by a second predefined time. These predefined times by which the anticipated time for discharge is adjusted may be based upon historical data, such as the effect upon the discharge time occasioned by a patient who had the same condition and who similarly failed to satisfy the same progression step. The processor may also be configured to repeatedly determine the anticipated discharge date/time as additional patient data is received and to further delay the anticipated discharge date if the patient continues to fail to satisfy a respective progression step or to accelerate the anticipated discharge date if the patient satisfies the progression steps sooner than anticipated. In any event, the processor may be configured to adjust the anticipated discharge date forwardly or backwardly by predefined amounts associated with the status of each of the progression steps.

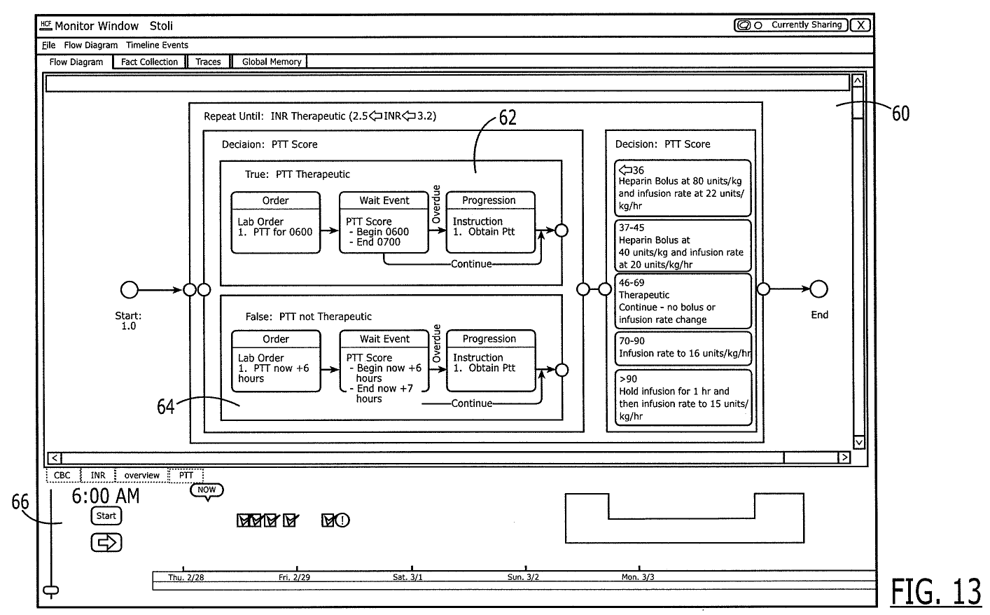

As described above, in conjunction with FIG. 7, the processor 24 of the clinical process driver 15 may be configured to provide additional information regarding a progression step upon the selection of the respective progression step. In one embodiment in which a selected progression step is associated with a multi-step medical treatment, the processor may be configured to display a flow diagram 60 of the multi-step medical treatment as well as an indication of the status of the multi-step medical treatment. With reference to FIG. 13, for example, a multi-step medical treatment for maintaining the international normalized ratio (INR) in a therapeutic range, such as within the range of 2.5 to 3.0, is depicted. The particular multi-step medical treatment of FIG. 13 is provided by way of example and the flow diagram of other medical treatments may be similarly provided in response to the selection of other progression steps.

As shown in FIG. 13, however, a decision was initially made as to whether the PTT score was therapeutic or not. In the illustrated embodiment, a PTT score of 46-69 is considered therapeutic with other PTT scores are not considered therapeutic. If the PTT score is considered to be therapeutic, the upper path 62 of the flow diagram 60 is followed in which a lab order for a PTT is ordered for 6 am with the PTT score expected to be determined between 6 am and 7 am. If the PTT score is received between 6 am and 7 am, the process continues with the PTT score being compared to the predefined ranges that define whether the PTT score is therapeutic or not. As noted in the flow chart, the failure to obtain the PTT score between 6 am and 7 am results in an overdue status with an instruction being provided by the processor 30 to an appropriate healthcare individual to obtain the PTT such that the multi-step medical treatment can be continued. Once the PTT is received and compared to the predefined ranges, the process ends if the PTT score is therapeutic. Otherwise, if the PTT score is found not to be therapeutic, remedial action is taken as described below, and the lower 64 path of the flow diagram is followed in order to subsequently repeat the process, such as in about six hours. In this regard, the lower path 64 of the flow diagram parallels the upper path, but is delayed in time by a predefined amount of time, such as six hours.

In terms of the comparison of the PTT score to the predefined ranges, if the PTT score is between 46 and 69, the PTT score is considered therapeutic, with no bolus or infusion rate change being introduced. However, if the PTT score is less than or equal to 36, the Heparin bolus is to be set at 80 units per kilogram, and the infusion rate is to be set at 22 units per kilogram per hour. Similarly, if the PTT score is between 37 and 45, the Heparin bolus is set to 40 units per kilogram, and the infusion rate is set to 20 units per kilogram per hour. Alternatively, if the PTT score exceeds the therapeutic range, such as by being between 70 and 90, the infusion rate may be changed to 16 units per kilogram per hour, while if the PTT score exceeds 90, the infusion may be held or ceased for one hour and then resumed with an infusion rate of 15 units per kilogram per hour.

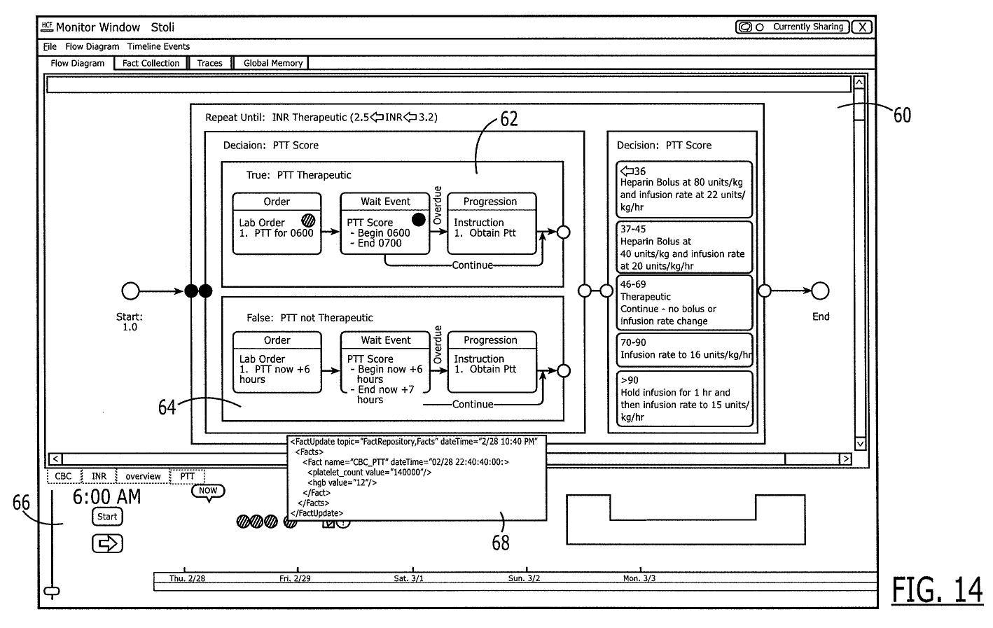

In addition to the flow diagram 60, the processor 24 may generate and cause to be displayed a timeline 66 which illustrates the time at which each step of the medical treatment (as represented by different blocks of a flow diagram) are to be performed. Additionally, in one embodiment, the processor may configure the timeline so as to be responsive to the selection of an item from the timeline, such as by placing the cursor on a respective item in the timeline. In this embodiment, the selection of an item in the timeline may cause the processor to display the underlying data that has been collected in association with the respective activity represented by the selected item, as shown in FIG. 14 in which the platelet count value is 140000, and the HGB value is 12. As shown, the timeline can include icons associated with each step of the multi-step medical treatment.

Once the multi-step medical treatment commences, the processor 24 may cause the graphical display of the flow diagram 60 to be annotated with indicia, such as colored or differently shaded dots indicating the status of the steps of the medical treatment that have been performed. In this regard, those steps of the medical treatment that have been initiated and completed may be flagged in one manner (e.g., cross-hatched circles in the illustrated embodiment), while those steps of the medical treatment that have been initiated, but not yet completed may be flagged in another manner (e.g., solidly colored circles in the illustrated embodiment). As shown in FIG. 14, for example, the multi-step medical treatment has commenced with an order for the PTT at 6 am and with the process now awaiting the PTT score. As such, the block of the flow diagram associated with ordering the PTT at 6 am has been indicated to be both initiated and completed, while the block associated with waiting for the PTT score between 6 am and 7 am is indicated to have been initiated, but not yet completed. Similar indications may be provided in conjunction with the larger blocks representing multi-step portions of the medical treatment, such as the block associated with determining the PTT and the block associated with repeating this process of determining the PTT score until the INR is considered to be therapeutic. As indicated in the timeline 66 associated with the multi-step medical treatment, the timeline may also include indications associated with each entry in the timeline so as to provide an indication as to whether an entry has been initiated and completed, or not.

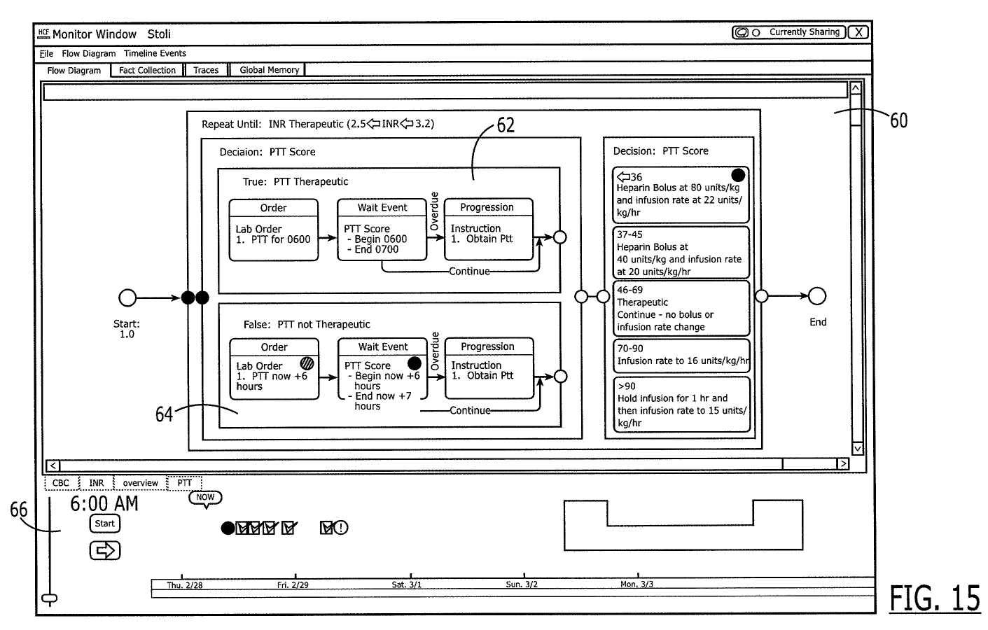

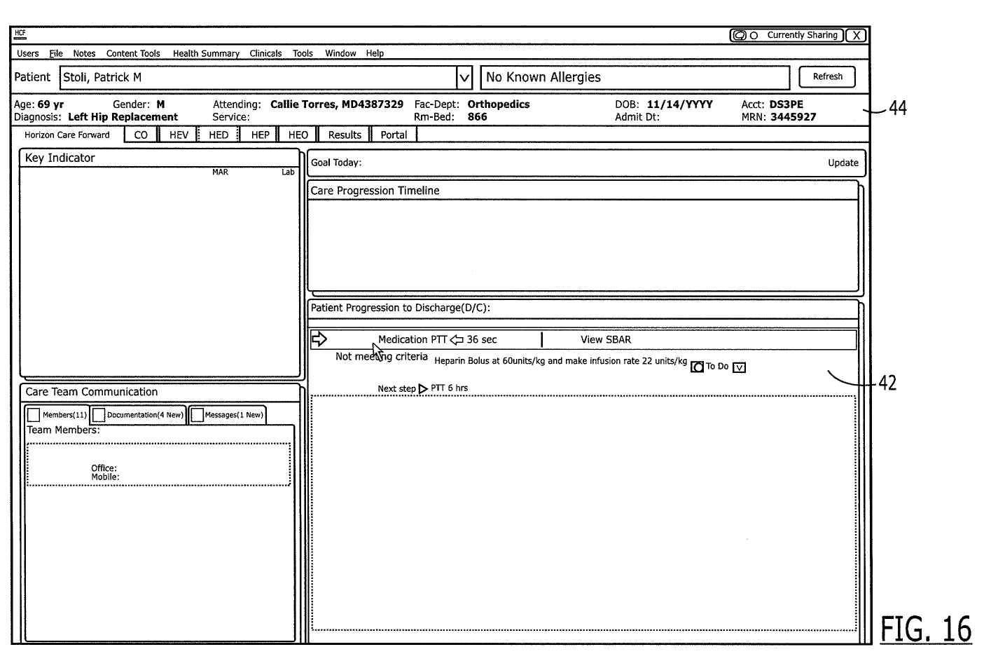

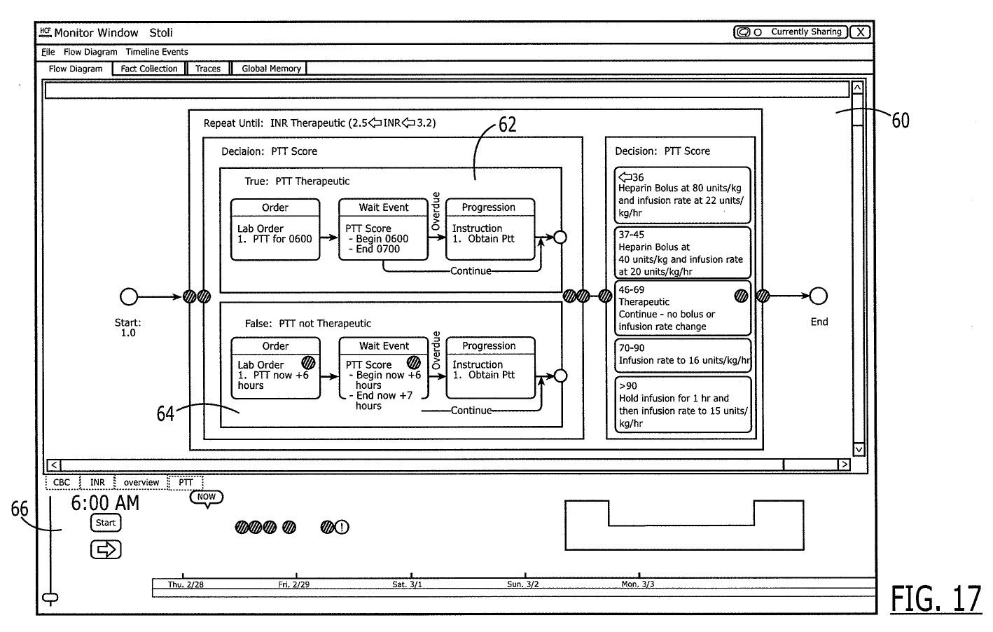

In order to illustrate the manner in which the progress of the multi-step medical treatment is represented, the graphical display of FIG. 15 illustrates that the initial PTT score was found to be between 37 and 45. As the PTT valve was not therapeutic, the prescribed remedial action is taken by appropriately adjusting the Heparin bolus and the infusion rate and the process is repeated. In this regard, the lower path 64 of the flow diagram 60 is taken by ordering another PTT for six hours later and then awaiting the PTT score. The results of the multi-step medical treatment may also be reflected in the care progression plan 20. In this regard, FIG. 16 illustrates a progression step that the processor 30 may supplement or add to the care progression plan in response to the PTT score being between 37 and 45 as in the example of FIG. 15. Consistent with the status of the multi-step medical treatment reflected in FIG. 15, the progression step identifies the issue, that is, the PTT score being between 37 and 45, as well as the steps to be taken in an effort to remedy the situation as well as the next test to be performed and the time associated therewith. This process may be repeated until, as shown in FIG. 17, the PTT score falls within there therapeutic range. As such, the processor may be configured to provide this additional level of detail to a healthcare professional in order to assist in the performance of the multi-step medical treatment. Moreover, the results of the multi-step medical treatment, including the intermediate results, may be reflected by updated progression steps or additional progression steps that provide an indication of the additional activities to be performed and the timing of those additional activities.

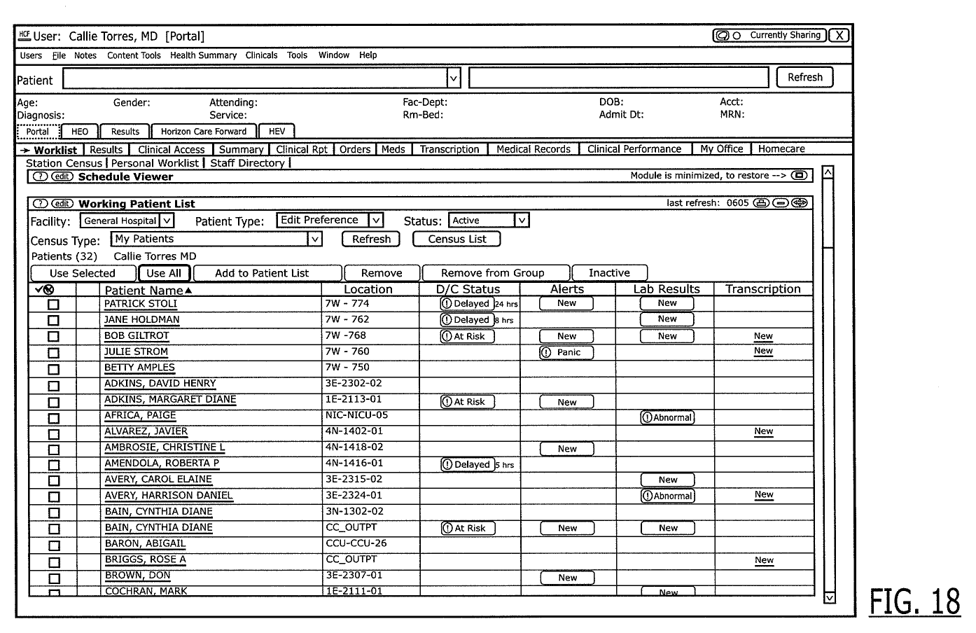

In one embodiment, the processor 24 may also be configured to provide a higher level view of the status of each of a plurality of different patients of a healthcare professional, such as a doctor. As shown in FIG. 18, the processor may identify each of a plurality of patients and their respective locations, as well as the discharge status, the alert status, the lab result status and the transcription status of each patient. As such, a physician or other healthcare professional can quickly determine matters that are awaiting their attention or which need their review and may also focus upon those patients for which the discharge has been delayed or is at risk. As shown, alerts of a predetermined type, such as panic alerts, may be highlighted, and abnormal lab results may be similarly highlighted in order to be quickly identified by the healthcare professional. Further, an indication of the length of time by which the discharge has been delayed may be provided. The processor may determine the discharge status and the length of any delay in the discharge based upon the determination of the anticipated discharge date/time in conjunction with the generation and display of the care progression plan, as described above.

The system, method and computer program product of one embodiment may also be configured to operate in a simulation mode. In this regard, the processor 24 may be configured to implement an reversed clock which permits the sequence of events to be reversed or an accelerated clock, the movement of which permits the events that occur over a longer period of time, such as a few days, to appear to occur in a shorter period of time, such as a few seconds or minutes, thereby providing, for example, an animation simulation. The rate of acceleration of the clock may be predefined or may be selected by a user. By way of example, an event may be back charted by charting an event that occurred some time in the past at a later time, e.g., at the end of a shift or the conclusion of a busy period. Once the back charted event has been entered, the processor may permit the current state to be recomputed from the point in the time of the back charted event to the present time. As a result of the simulation capabilities, however, this recomputation may be performed relatively rapidly with the use of an accelerated clock. Additionally, clinicians or other users may desire to analyze how a patient has reached the current state and, as such, the processor of one embodiment may permit the various events to be played, e.g., simulated, in reverse chronological order.

As described above, FIG. 19 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the clinical process driver 15 and executed by its processor 24. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Accordingly, the method, apparatus and computer program product of embodiments of the present invention monitor and direct patient care based on assigned protocols designed by healthcare professionals. In this regard, embodiments of the present invention may reason over the patient data using predefined logic and rules and provides directions for actions to be taken, such as in the form of the patient progression steps and the information included within the patient progression steps regarding the next action to be performed. As described, embodiments of the present invention may create and suggest medical orders for tests, medications, medical equipment, etc. based on predefined logic and may monitor the systems that report the results of such orders to insure compliance and effectiveness. Further, embodiments of the present invention may track specific parameter(s) for clinically significant deviations or trends and may trigger an alert if a significant variation or trend is detected. Embodiments of the present invention therefore permit an organization to more consistently implement its best practices by representing the best practices in a knowledge model that describes how a patient should progress to discharge and beyond, and how to respond to the anticipated deviations from the normal path to recovery. Indeed, embodiments of the present invention monitor the patient condition relative to the knowledge model and guide the healthcare professionals, such as by generating and presenting an updated care progression plan, on when and how to advance the care to the next phase and/or how to manage deviations from the expected progression based on evidence and best practices.

Many modifications and other-embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating management of patient progression steps toward discharge, the method comprising:
identifying a plurality of progression steps to be completed prior to discharge of a patient and for which all prerequisites for execution have been met, wherein identifying the plurality of progression steps comprises identifying a critical path of progression steps that are to be satisfied to discharge the patient by a discharge order;
displaying the plurality of progression steps and an indication of a status of a respective progression step indicating whether the respective progression step remains unsatisfied;
receiving a selection of a progression step and displaying information regarding the selected progression step;
receiving input data regarding at least one progression step and updating the indication of the status of the at least one progression step based upon whether the at least one progression step has now been satisfied or remains unsatisfied; and
determining, via a processor, an updated discharge date based upon the plurality of progression steps and the respective status of the plurality of progression steps as updated based upon the input data, wherein determining the updated discharge date comprises reprojecting the critical path based upon the plurality of progression steps and the respective status of the progression steps as updated based on the input data.

2. A method according to claim 1 further comprising differently ordering the plurality of progression steps depending upon a type of user.

3. A method according to claim 1 wherein at least one progression step has associated criteria to be met to be satisfied, wherein the method further comprises determining if the criteria associated with the at least one progression step have been met, and wherein displaying the indication of the status comprises displaying an indication of the status of the at least one progression step indicating whether the criteria have been met or have not been met.

4. A method according to claim 1 further comprising receiving an input requesting preparation of a report relating to at least one progression step and automatically preparing the report at least partially based upon the input data.

5. A method according to claim 1 further comprising automatically preparing one of an order or a pre-order in response to the status of at least one progression step.

6. A method according to claim 1 further comprising receiving an input requesting an update of a chart and automatically updating the chart at least partially based upon the input data.

7. A method according to claim 1 wherein displaying the plurality of progression steps comprises identifying a medical treatment to be performed in association with a respective progression step.

8. A method according to claim 1 wherein displaying information regarding the selected progression step comprises displaying a flow diagram of multi-step medical treatment to be performed in association with the selected progression step and providing an indication of a status of the multi-step medical treatment.

9. A method according to claim 8 wherein providing an indication of the status of the multi-step medical treatment comprises separately indicating at least one step of the multi-step medical treatment that has been both initiated and completed from at least one step of the multi-step medical treatment that has been initiated, but not yet completed.

10. A method according to claim 1 further comprising transforming the input data in accordance with an associated clinical concept to a structured clinical fact.

11. A method according to claim 10 further comprising:
applying one or more rules associated with the clinical concept to the structured clinical fact; and
generating additional data as a result of applying the one or more rules.

12. A method according to claim 11 wherein applying one or more rules comprises applying at least one trending rule to the structured clinical fact, and wherein generating additional data comprises generating data reflective of application of the at least one trending rule to the structured clinical fact.

13. A method according to claim 1 further comprising simulating performance of a plurality of progression steps in accordance with one of an accelerated clock or a reversed clock.

14. A method according to claim 1 wherein identifying a plurality of progression steps further comprises identifying a plurality of paths of progression steps with each path of progression steps capable to be performed in parallel.

15. An apparatus for facilitating management of patient progression steps toward discharge, the apparatus comprising a processor configured to:
identify a plurality of progression steps to be completed prior to discharge of a patient and for which all prerequisites for execution have been met, wherein identifying the plurality of progression steps comprises identifying a critical path of progression steps that are to be satisfied to discharge the patient by a discharge order;
provide for display of the plurality of progression steps and an indication of a status of a respective progression step indicating whether the respective progression step remains unsatisfied;
receive a selection of a progression step and provide for display of information regarding the selected progression step;
receive input data regarding at least one progression step and update the indication of the status of the at least one progression step based upon whether the at least one progression step has now been satisfied or remains unsatisfied; and
determine an updated discharge date based upon the plurality of progression steps and the respective status of the plurality of progression steps as updated based upon the input data, wherein determining the updated discharge date comprises reprojecting the critical path based upon the plurality of progression steps and the respective status of the progression steps as updated based on the input data.

16. An apparatus according to claim 15 wherein the processor is further configured to differently order the plurality of progression steps depending upon a type of user.

17. An apparatus according to claim 15 wherein at least one progression step has associated criteria to be met to be satisfied, wherein the processor is further configured to determine if the criteria associated with the at least one progression step have been met, and wherein the processor being configured to provide for display of the indication of the status comprises the processor being configured to provide for display of an indication of the status of the at least one progression step indicating whether the criteria have been met, are incomplete, or have not been met.

18. An apparatus according to claim 15 wherein the processor is further configured to receive an input requesting preparation of a report relating to at least one progression step and to automatically prepare the report at least partially based upon the input data.

19. An apparatus according to claim 15 wherein the processor is further configured to automatically prepare one of an order or a pre-order in response to the status of at least one progression step.

20. An apparatus according to claim 15 wherein the processor is further configured to receive an input requesting an update of a chart and to automatically update the chart at least partially based upon the input data.

21. An apparatus according to claim 15 wherein the processor being configured to provide for display of the plurality of progression steps comprises the processor being configured to identify a medical treatment to be performed in association with a respective progression step.

22. An apparatus according to claim 15 wherein the processor being configured to provide for display of information regarding the selected progression step comprises the processor being configured to provide for display of a flow diagram of multi-step medical treatment to be performed in association with the selected progression step and to provide an indication of a status of the multi-step medical treatment.

23. An apparatus according to claim 22 wherein the processor being configured to provide an indication of the status of the multi-step medical treatment comprises the processor being configured to separately indicate at least one step of the multi-step medical treatment that has been both initiated and completed from at least one step of the multi-step medical treatment that has been initiated, but not yet completed.

24. An apparatus according to claim 15 wherein the processor is further configured to transform the input data in accordance with an associated clinical concept to a structured clinical fact.

25. An apparatus according to claim 24 wherein the processor is further configured to:
apply one or more rules associated with the clinical concept to the structured clinical fact; and
generating additional data as a result of applying the one or more rules.

26. An apparatus according to claim 25 wherein the processor being configured to apply one or more rules comprises the processor being configured to apply at least one trending rule to the structured clinical fact, and wherein the processor being configured to generate additional data comprises the processor being configured to generate data reflective of application of the at least one trending rule to the structured clinical fact.

27. An apparatus according to claim 15 wherein the processor is further configured to simulate performance of a plurality of progression steps in accordance with one of an accelerated clock or a reversed clock.

28. An apparatus according to claim 15 wherein the processor is configured to identify the plurality of progression steps by identifying a plurality of paths of progression steps with each path of progression steps capable to be performed in parallel.

29. A computer program product for facilitating management of patient progression steps toward discharge, the computer program product comprising at least one computer-readable storage medium having computer-readable program instructions stored therein, the computer-readable program instructions comprising:
a program instruction configured to identify a plurality of progression steps to be completed prior to discharge of a patient and for which all prerequisites for execution have been met, wherein the program instruction configured to identify the plurality of progression steps comprises program instructions configured to identify a critical path of progression steps that are to be satisfied to discharge the patient by a discharge order;
a program instruction configured to provide for display of the plurality of progression steps and an indication of a status of a respective progression step indicating whether the respective progression step remains unsatisfied;
a program instruction configured to receive a selection of a progression step and to provide for display of information regarding the selected progression step;
a program instruction configured to receive input data regarding at least one progression step and to update the indication of the status of the at least one progression step based upon whether the at least one progression step has now been satisfied or remains unsatisfied; and
a program instruction configured to determine an updated discharge date based upon the plurality of progression steps and the respective status of the plurality of progression steps as updated based upon the input data, wherein the program instruction configured to determine the updated discharge date comprises a program instruction configured to reproject the critical path based upon the plurality of progression steps and the respective status of the progression steps as updated based on the input data.

30. A computer program product according to claim 29 further comprising a program instruction configured to differently order the plurality of progression steps depending upon a type of user.

31. A computer program product according to claim 29 wherein at least one progression step has associated criteria to be met to be satisfied, wherein the computer-readable program instructions further comprise a program instruction configured to determine if the criteria associated with the at least one progression step have been met, and wherein the program instruction configured to provide for display of the indication of the status comprises a program instruction configured to provide for display of an indication of the status of the at least one progression step indicating whether the criteria have been met, are incomplete, or have not met.

32. A computer program product according to claim 29 further comprising a program instruction configured to receive an input requesting preparation of a report relating to at least one progression step and a program instruction configured to automatically prepare the report at least partially based upon the input data.

33. A computer program product according to claim 29 further comprising a program instruction configured to automatically prepare one of an order or a pre-order in response to the status of at least one progression step.

34. A computer program product according to claim 29 further comprising a program instruction configured to receive an input requesting an update of a chart and a program instruction configured to automatically update the chart at least partially based upon the input data.

35. A computer program product according to claim 29 wherein the program instruction configured to provide for display of the plurality of progression steps comprises a program instruction configured to identify a medical treatment to be performed in association with a respective progression step.

36. A computer program product according to claim 29 wherein the program instruction configured to provide for display of information regarding the selected progression step comprises a program instruction configured to provide for display of a flow diagram of multi-step medical treatment to be performed in association with the selected progression step and a program instruction configured to provide an indication of a status of the multi-step medical treatment.

37. A computer program product according to claim 36 wherein the program instruction configured to provide an indication of the status of the multi-step medical treatment comprises a program instruction configured to separately indicate at least one step of the multi-step medical treatment that has been both initiated and completed from at least one step of the multi-step medical treatment that has been initiated, but not yet completed.

38. A computer program product according to claim 29 further comprising a program instruction configured to transform the input data in accordance with an associated

38. A computer program product according to claim 29 further comprising a program instruction configured to transform the input data in accordance with an associated clinical concept to a structured clinical fact.

39. A computer program product according to claim 38 further comprising:
a program instruction configured to apply one or more rules associated with the clinical concept to the structured clinical fact; and
a program instruction configured to generate additional data as a result of applying one or more rules.

40. A computer program product according to claim 39 wherein the program instruction configured to apply one or more rules comprises a program instruction configured to apply at least one trending rule to the structured clinical fact, and wherein the program instruction configured to generate additional data comprises a program instruction configured to generate data reflective of application of the at least one trending rule to the structured clinical fact.

41. A computer program product according to claim 29 further comprising a program instruction configured to simulate performance of a plurality of progression steps in accordance with one of an accelerated clock or a reversed clock.

42. An computer program product according to claim 29 wherein the program instructions configured to identify the plurality of progression steps comprises a program instruction configured to identify a plurality of paths of progression steps with each path of progression steps capable to be performed in parallel.
